(19) United States
(12) Patent Application Publication
(10) Pub. No.: US 2025/0117601 A1
(43) Pub. Date: Apr. 10, 2025

(54) METHOD FOR INFORMATION PROCESSING, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Huilin Li, Beijing (CN); Yi Li, Beijing (CN); Lunan Zhao, Beijing (CN); Jie Liu, Beijing (CN); Li Ma, Beijing (CN); Tao Li, Beijing (CN); Tianzhong Hu, Beijing (CN); Yu Chen, Beijing (CN); Yongjuan Che, Beijing (CN); Aowei Li, Beijing (CN); Hanmeng Liu, Beijing (CN); Shouke Qin, Beijing (CN)

(73) Assignee: BEIJING BAIDU NETCOM SCIENCE TECHNOLOGY CO., LTD., Beijing (CN)

(21) Appl. No.: 18/987,693

(22) Filed: Dec. 19, 2024

(30) Foreign Application Priority Data
Sep. 13, 2024 (CN) 202411289320.3

(51) Int. Cl. G06F 40/40; G06F 40/284; G06F 40/30

(52) U.S. Cl. CPC G06F 40/40; G06F 40/284; G06F 40/30

(57) ABSTRACT

A computer-implemented method for information processing includes: obtaining text information, in which the text information includes first text information of a resource to be commented on and second text information of a candidate prompt; selecting a target prompt from the candidate prompts based on the text information; and generating comment information of the resource to be commented on, based on the resource to be commented on and the target prompt.

### CROSS-REFERENCE TO RELATED APPLICATION

The present application is based upon and claims priority to Chinese Patent Application No. 2024112893203, filed on Sep. 13, 2024, the entire contents of which are incorporated herein by reference.

### TECHNICAL FIELD

The present disclosure relates to a field of artificial intelligence technology, specifically to technical fields of deep learning, large model, and natural language processing, and specifically to a method and an apparatus for information processing, an electronic device, and a storage medium.

### BACKGROUND

The comments are manually made on social media platforms, which is not only time-consuming but also inefficient. This is difficult to meet the needs of large-scale promotion and interaction. As a number of users on the platforms continues to grow, more efficient ways are needed to manage their online images and interactions with users. With the continuous progress of artificial intelligence technology, artificial intelligence algorithms may simulate human behaviors and achieve automatic operations. For example, an automatic commenting tool, as a new commenting tool, may help users to make automatic comments on resources on the social media platforms. How to generate high-quality comments matching the resources based on prompts input by the automatic commenting tool has become a hot topic of research.

### SUMMARY

According to a first aspect of the present disclosure, a method for information processing is provided, including: obtaining text information, in which the text information includes first text information of a resource to be commented on and second text information of a candidate prompt; selecting an optimal target prompt from the candidate prompts based on the text information; and generating comment information of the resource to be commented on, based on the resource to be commented on and the target prompt.

According to a second aspect of the present disclosure, an electronic device is provided, including: at least one processor; and a memory connected in communication with the at least one processor and storing instructions executable by the at least one processor, in which when the instructions are executed by the at least one processor, the method for information processing in the above first aspect of the embodiments is implemented.

According to a third aspect of the present disclosure, a non-transitory computer-readable storage medium storing computer instructions is provided, on which computer programs/instructions are stored, in which the computer instructions are configured to cause a computer to implement the method for information processing in the above first aspect of the embodiments.

### BRIEF DESCRIPTION OF THE DRAWINGS

The accompanying drawings are used for a better understanding of the disclosure and do not constitute a limitation of the disclosure.

FIG. 1 is a flowchart of a method for information processing according to the embodiments of the present disclosure.

FIG. 2 is a flowchart of another method for information processing according to the embodiments of the present disclosure.

FIG. 2a is a schematic diagram of a text information combination according to the embodiments of the present disclosure.

FIG. 3 is a flowchart of another method for information processing according to the embodiments of the present disclosure.

FIG. 4 is a flowchart of another method for information processing according to the embodiments of the present disclosure.

FIG. 5 is a block diagram of an apparatus for information processing according to the embodiments of the present disclosure.

FIG. 6 is a block diagram of an electronic device to implement the method for information processing according to the embodiments of the present disclosure.

### DETAILED DESCRIPTION

Exemplary embodiments of the disclosure are described hereinafter in conjunction with the accompanying drawings, which include various details of the embodiments of the disclosure in order to aid in understanding, and should be considered exemplary only. Accordingly, one of ordinary skill in the art should recognize that various changes and modifications may be made to the embodiments described herein without departing from the scope of the disclosure. Similarly, descriptions of well-known features and structures are omitted from the following description for the sake of clarity and brevity.

The method and the apparatus for information processing, and the electronic device in the embodiments of the present disclosure are described below with reference to the accompanying drawings.

Artificial Intelligence (AI) is a discipline that studies thinking processes and intelligent behaviors (such as learning, reasoning, thinking, planning, etc.) of humans simulated by computers, with technologies at both a hardware level and a software level. AI hardware technology generally includes a computer vision technology, a speech recognition technology, a natural language processing technology and main aspects thereof such as learning/deep learning, a big data processing technology, a knowledge graph technology.

Natural Language Processing (NLP) is an important direction in the fields of computer science and AI. The NLP studies various theories and methods that perform effective communication between a human being and a computer with a natural language. The NLP is a science that integrates linguistics, computer science and mathematics. The NLP is mainly used in aspects such as machine translation, public opinion monitoring, automatic summarization, opinion extraction, text classification, question and answer, text semantic comparison, speech recognition.

Deep Learning (DL) is a new research direction in the field of machine learning (ML), which is introduced to make the ML closer to its original goal-AI. The DL is to learn inner laws and hierarchical representations of sample data, and the information obtained during the learning process is of great help in the interpretation of data such as a word, an image, and a sound. The ultimate goal is to make machines have the same analytical and learning capabilities as humans, and able to recognize data such as a word, an image, and a sound. The DL is a complex ML algorithm that achieves far better results in speech and image recognition than the related art.

Intelligent search is a new generation of search engine that combines the AI technology. In addition to conventional functions, such as quick searching and correlation degree ranking, it also provides functions like a user role registration, an automatic recognition of user interests, a semantic understanding of content, intelligent information filtering and pushing.

Large model refers to a ML model with large-scale parameters and a complex computational structure. This model is typically built with deep neural networks with billions or even hundreds of billions of parameters. The design goal of the large model is to improve the expressiveness and prediction performance of the model, and to deal with more complex tasks and data. The large model is widely used in a variety of fields, including the NLP, computer vision, speech recognition, and a recommendation system. The large model learns complex patterns and features by training massive amounts of data, so as to have a strong generalization capability, which may make accurate predictions about data unseen previously.

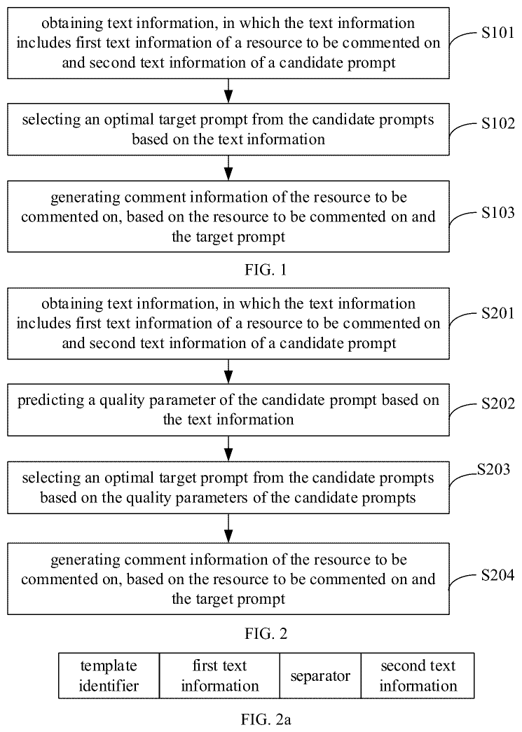

FIG. 1 is a flowchart of a method for information processing according to the embodiments of the present disclosure.

As shown in FIG. 1, the method for information processing may include but be not limited to the following steps at S101 to S103.

At S101, text information is obtained, in which the text information includes first text information of a resource to be commented on and second text information of a candidate prompt.

In some embodiments, the resource to be commented on may be resource(s) on various resource platforms, which may include but are not limited to: a news client, a social media platform, a video sharing website, etc. The resource to be commented on may include but not limited to: an article, a picture, an audio, a video, etc. For example, the article may be text material in an academic forum. For another example, the picture may be an image resource published on social platforms. For another example, the audio may be a song, a piece of music, a radio drama, etc. For another example, the video may be a short video, or a TV series, a movie and other resources.

In some embodiments, the resource to be commented on may be understood as a resource that users browse on a certain platform, for example, may be a short video currently playing on a social platform.

In some embodiments, the first text information of the resource to be commented on may be used to describe text information of the resource to be commented on.

In some embodiments, the candidate prompt is a prompt corresponding to the resource to be commented on that generates a comment. In the embodiments of the present disclosure, there may be two or more candidate prompts. Optionally, a plurality of prompts may be directly input by the users or generated based on comment demand information input by the users.

In some embodiments, the second text information of the candidate prompt may be generated based on original contents of the candidate prompt.

At S102, an optimal target prompt is selected from the candidate prompts based on the text information.

In some embodiments, a feature may be extracted from the text information after obtaining the text information, a matching degree or an association degree between the candidate prompt and the resource to be commented on is determined by evaluating the candidate prompt based on the extracted feature. Then, the optimal target prompt is determined from the candidate prompts based on the matching degrees or association degrees of the candidate prompts.

At S103, comment information of the resource to be commented on is generated based on the resource to be commented on and the target prompt.

In some embodiments, the comment information of the resource to be commented on is generated based on the resource to be commented on and the target prompt after the target prompt is obtained. Optionally, the resource to be commented on and the target prompt are input into an automatic commenting tool, via which the comment information of the resource to be commented on is generated.

In some embodiments, the comment information of the resource to be commented on may include but not limited to at least one of: a comment text of the resource to be commented on, a comment video of the resource to be commented on, a comment picture of the resource to be commented on, or a comment audio of the resource to be commented on.

In some embodiments, a comment area corresponding to a user may include a plurality of comment fill areas, for example, it may include but not limited to a text fill area, a video fill area, a picture fill area, and an audio fill area.

In some embodiments, after obtaining the comment information of the resource to be commented on, each type of comment content in the comment information may be filled into a corresponding fill area.

In the method for information processing in the embodiments of the present disclosure, the optimal target prompt is selected from the candidate prompts based on the text information of the resource to be commented on and the candidate prompts, and the selected target prompt best matches the style of the resource to be commented on, so that the generated comment information of the resource to be commented on may be suitable for the content of the resource be commented on, which not only improves the quality of the comment information, but also improves the accuracy and intelligence level of the comment information, and is conducive to increasing the user experiences on the resource sharing platform.

FIG. 2 is a flowchart of another method for information processing according to the embodiments of the present disclosure.

As shown in FIG. 2, the method for information processing may include but not limited to the following steps at S201 to S204.

At S201, text information is obtained, in which the text information includes first text information of a resource to be commented on and second text information of a candidate prompt.

In some embodiments, after obtaining the first text information and the second text information, the text information may be obtained by combining the first text information and the second text information.

In some embodiments, the text information may be obtained by combining the first text information and the second text information based on a configured preset template, so that the model may be used to perform accurate recognition and analysis, and the processing efficiency and accuracy of the model may be improved. Optionally, the preset template may include a template identifier, a fill position of the first text information, and a fill position of the second text information, and a separator is further set between the fill position of the first text information and the fill position of the second text information, as shown in FIG. 2a.

Exemplarily, the text information may be constructed in a way of “relevant SUG:<ANS>resource title content<SUG>prompt content”, in which the prompt content retains first 250 characters. The “relevant SUG: <ANS>” may be the template identifier, the “resource title content” is the first text information, the “<SUG>” is the separator, and the “prompt content” is the second text information. It may be understood that this is only an example of the preset template and is not a condition to limit the present disclosure.

In some embodiments, the first text information may be key information of the resource to be commented on, in which the key information may include but not limited to at least one of: a topic, a title, a label, or summary information. The first text information is determined by the topic, the title, the label or the summary information of the resource to be commented on, which may make the first text information represent the content of the resource to be commented on more accurately.

Optionally, when the resource to be commented on carries at least one of: a title, a topic, or a label, the at least one of the title, the topic, or the label may be directly taken as the first text information of the resource to be commented on.

Optionally, when the resource to be commented on does not carry any key information, such as a title, a topic, or a label, a semantic analysis and content understanding may be performed on the resource to be commented on, and the first text information of the resource to be commented on may be generated based on understanding information of the resource to be commented on.

Optionally, at least one of a title, a topic, or a label of the resource to be commented on may be generated based on deep understanding information, in which the at least one of the title, the topic, or the label may be taken as the first text information of the resource to be commented on.

Optionally, the summary information may be generated based on the depth understanding information of the resource to be commented on, in which the summary information may be taken as the first text information of the resource to be commented on.

Optionally, the understanding information of the resource be commented on may be output by performing semantic analysis and content understanding of the resource to be commented on based on a pre-trained large language model.

In the embodiments of the present disclosure, performing the semantic analysis and the content understanding of the resource to be commented on may not only ensure to obtain the first text information, but also ensure that the first text information is more suitable for (matched to) the resource to be commented on, so as to truly reflect the content of the resource.

In some embodiments, a part of the original content is extracted from the original content of the candidate prompt and taken as the second text information of the candidate prompt. Optionally, the preceding segment of content may be extracted from the original content of the candidate prompt and taken as the second text information of the candidate prompt. Optionally, the middle segment of content may be extracted from the original content of the candidate prompt and taken as the second text information of the candidate prompt. Optionally, a number of words to be extracted may be set, and the second text information of the candidate prompt is obtained by extracting from front to back based on the number of the words to be extracted from the original content of the candidate prompt. Optionally, the number of words to be extracted may be a pre-configured number of words, for example, 250 words. The gist content of the prompt is extracted, rather than the whole information of the prompt, which may reduce the amount of traffic, improve the prediction efficiency, and save computing resources.

In some embodiments, the original content of the candidate prompt may be summarized, and the summary information is the second text information of the candidate prompt.

In some embodiments, the original content of the candidate prompt may be identified, from which the content related to user input information may be identified as the second text information of the candidate prompt.

In the embodiments of the present disclosure, obtaining the second text information from the prompt ensures that the second text information may fully express the gist information of the prompt, which is conducive to the quality prediction of subsequent prompts.

For optional implementation of S201, please refer to the optional implementation of S101 in FIG. 1 and other relevant parts of the embodiments involved in FIG. 1, which is not repeated here.

At S202, a quality parameter of the candidate prompt is predicted based on the text information.

In some embodiments, an identity (ID) of a token of the text information and an ID of a sparse feature of the text information may be obtained by segmenting the text information into the token and extracting the sparse feature from the text information, and a fused feature may be further obtained by fusing the ID of the token and the ID of the sparse feature.

Further, the quality parameter of the candidate prompt may be obtained by predicting the quality parameter of the candidate prompt based on the fused feature.

The quality parameter may include but not limited to: a score of the candidate prompt, a matching degree, and a comment staying duration.

Optionally, the score of the candidate prompt may be configured to evaluate a quality of the candidate prompt. Optionally, the matching degree of the candidate prompt may be configured to evaluate a matching degree or a correlation degree between the candidate prompt and the resource to be commented on.

Optionally, the comment staying duration of the candidate prompt may be configured to reflect a duration of the user staying on the comment information generated based on the candidate prompt, and further, to reflect a quality of the candidate prompt. In the embodiments of the present disclosure, the staying duration of the comment information is positively correlated with the quality of the comment information, that is, the longer the staying duration of the comment information is, the better the quality of the comment information is; and the shorter the staying duration of the comment information is, the worse the quality of the comment information is.

It should be understood that the shorter the staying duration of the comment information, which reflects that the comment information is not attractive enough to the user, or the interest of the user in the comment information is low, the lower the willingness for the user to interact with the comment information, which may not effectively retain users. The longer the staying duration of the comment information is, the greater the attraction of the comment information to the user is, or the higher the interest of the user in the comment information is, which is conducive to the interaction between the user and the comment information, such as commenting on and liking the comment information, so as to reduce the possibility of the loss of users and increase the possibility of the retention of users.

At S203, the optimal target prompt is selected from the candidate prompts based on the quality parameters of the candidate prompts.

In some embodiments, a prompt with an optimal quality is selected as the target prompt by ranking the candidate prompts based on the quality parameters of the candidate prompts.

In some embodiments, the candidate prompts may be ranked from high to low based on the scores of the candidate prompts, and the candidate prompt ranks at the top may be selected as the target prompt with the optimal quality.

In some embodiments, the candidate prompts may be ranked from high to low based on the matching degrees of the candidate prompts, and the candidate prompt ranks at the top may be selected as the target prompt with the optimal quality.

In some embodiments, the candidate prompts may be ranked from high to low based on the comment staying durations of the candidate prompts, and the candidate prompt ranks at the top may be selected as the target prompt with the optimal quality, so as to increase the interest of the user in the comment information, which is conducive to improving the user experiences.

In the embodiments of the present disclosure, the target prompt with the optimal quality is selected from the candidate prompts, and the selected target prompt best matches the style of the resource to be commented on, which may generate high-quality comment information that is more suitable to the content of the resource to be commented on. In this way, more users may see richer comment content, and pushing of the content to be commented on may be increased.

At S204, comment information of the resource to be commented on is generated based on the resource to be commented on and the target prompt.

Optionally, the comment information may be a combination of a comment text and a comment video. Optionally, the comment information may be a combination of a comment text and a comment picture. Optionally, the comment information may be a combination of a comment text and a comment audio. In the embodiments of the present disclosure, multi-modal comment information may be generated, which is conducive to enriching the form of the comments, further increasing the interest of the user in the comment information and improving the user experiences.

In some embodiments, the comment video may be generated based on the comment text, or may be a related video searched from a video database based on the comment text, or may be a related video searched from a video database based on the resource to be commented on. Optionally, key information and label information of the resource to be commented on may be obtained, and a related video may be searched from the video database based on the key information and the label information.

For optional implementation of S204, please refer to the optional implementation of S103 in FIG. 1 and other relevant parts of the embodiments involved in FIG. 1, which is not repeated here.

In the method for information processing in the embodiments of the present disclosure, the optimal target prompt is selected from the candidate prompts based on the text information of the resource to be commented on and the candidate prompts, and the selected target prompt best matches the style of the resource to be commented on, so that the generated comment information of the resource to be commented on may be suitable for the content of the resource to be commented on, which not only improves the quality of the comment information, but also improves the accuracy and intelligence level of the comment information, and is conducive to increasing the user experiences on the resource sharing platform. Especially, a number of comments is often related to a popularity of resources on the social media platforms. The intelligent comments may simplify a commenting operation, improve a commenting speed, and quickly increase a volume of comments, and it may be easier to push the resource to be commented on. By guiding the network traffic with the intelligent comments, more users may pay attention to the resource to be evaluated. Meanwhile, the intelligent comments may also be used to handle user inquiries and feedback, which may solve the problem of untimely feedback and further enhance the user satisfaction and the user experiences.

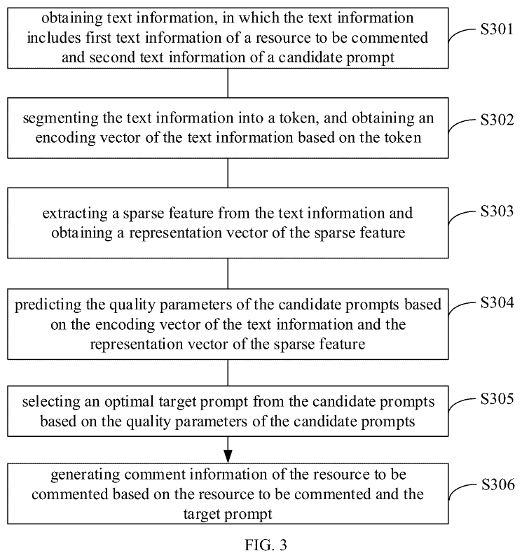

FIG. 3 is a flowchart of a method for information processing according to the embodiments of the present disclosure.

As shown in FIG. 3, the method for information processing may include but be not limited to the following steps at S301 to S306.

At S301, text information is obtained, in which the text information includes first text information of a resource to be commented on and second text information of a candidate prompt.

For optional implementation of S301, please refer to the optional implementation of S101 in FIG. 1, S201 in FIG. 2, and other relevant parts of the embodiments involved in FIG. 1 and FIG. 2, which is not repeated here.

At S302, the text information is segmented into a token, and an encoding vector of the text information is obtained based on the token.

In some embodiments, the text information is segmented into the token via a tokenizer, a representation vector of the token the token is obtained by processing the token via a first embedding layer, and the encoding vector of the text information is further obtained by encoding the representation vector of the token via an encoder, in which the encoding vector of the text information includes token ID information of the token.

At S303, a sparse feature is extracted from the text information and a representation vector of the sparse feature is obtained.

In some embodiments, the sparse feature extracted from the text information may include but not limited to a prompt number, a resource type, a resource category, a resource interest point, a resource cover image category, a plurality of combination features (each combines the above information), a prompt type, and a plurality of combination features (each combines partial information in the above information). Optionally, the sparse feature is shown in Table 1 below:

TABLE 1
sparse feature table

| Sparse feature | Description information |
|---|---|
| prompt_id | Prompt number |
| vt | resource type, news/mv/sv |
| cate | resource category level 1 |
| subcate | resource category level 2 |
| att_0 | resource interest point 1 |
| att_1 | resource interest point 2 |
| att_2 | resource interest point 3 |
| cover_cate | resource cover image category |
| prompt_vt | combination feature, prompt_id-vt |
| prompt_cate | combination feature, prompt_id-category level 1 |
| prompt_subcate | combination feature, prompt_id-category level 2 |
| prompt_cover_cate | combination feature, prompt_id-cover image |
| | category |
| prompt_type | prompt [symbol] , rag/deep |
| prompt_type_cate | combination feature, prompt |
| | type-category level 1 |
| prompt_type_subcate | combination feature, |
| | prompt type-category level |
| | 2 |

It may be understood that each element in Table 1 exists independently and is listed in the same table as an example, but it does not mean that all elements in the table must exist simultaneously as shown in the table. The value of each element is independent of any other element values in Table 1. Therefore, those skilled in the art may understand that the value of each element in Table 1 is an independent embodiment.

In some embodiments, the sparse feature may be extracted based on the above Table 1 to obtain an ID of the sparse feature. Furthermore, the representation vector of the sparse feature may be obtained by processing the ID of the sparse feature via a second embedding layer.

At S304, the quality parameters of the candidate prompts are predicted based on the encoding vector of the text information and the representation vector of the sparse feature.

In some embodiments, after the encoding vector of the text information and the representation vector of the sparse feature are obtained, a concatenated vector may be obtained by concatenating the encoding vector of the text information and the representation vector of the sparse feature. Furthermore, the concatenated vector is input into a deep neural network (DNN) based on a multi-layer perceptron (MLP) for quality prediction, and the quality parameters of the candidate prompts are predicted by the DNN based on the concatenated vector.

In the embodiments of the disclosure, in the process of predicting the quality parameters of the candidate prompts, attention is paid to both the text feature and the sparse feature of the text information, which may improve the accuracy of predicting the quality parameters of the prompts, facilitate subsequent selection of the accurate target prompt, and ensure the quality the of generated comment information.

At S305, the optimal target prompt is selected from the candidate prompts based on the quality parameters of the candidate prompts.

For optional implementation of S305, please refer to the optional implementation of 102 in FIGS. 1 and S203 in FIG. 2, and other relevant parts of the embodiments involved in FIG. 1 and FIG. 2, which is not repeated here.

At S306, comment information of the resource to be commented on is generated based on the resource to be commented on and the target prompt.

For optional implementation of S306, please refer to the optional implementation of 103 in FIGS. 1 and S204 in FIG. 2, and other relevant parts of the embodiments involved in FIG. 1 and FIG. 2, which is not repeated here.

In the method for information processing in the embodiments of the present disclosure, the optimal target prompt is selected from the candidate prompts based on the text information of the resource to be commented on and the candidate prompts, and the selected target prompt best matches the style of the resource to be commented on, so that the generated comment information of the resource to be commented on may be suitable for the content of the resource to be commented on, which not only improves the quality of the comment information, but also improves the accuracy and intelligence level of the comment information, and is conducive to increasing the user experiences on the resource sharing platform.

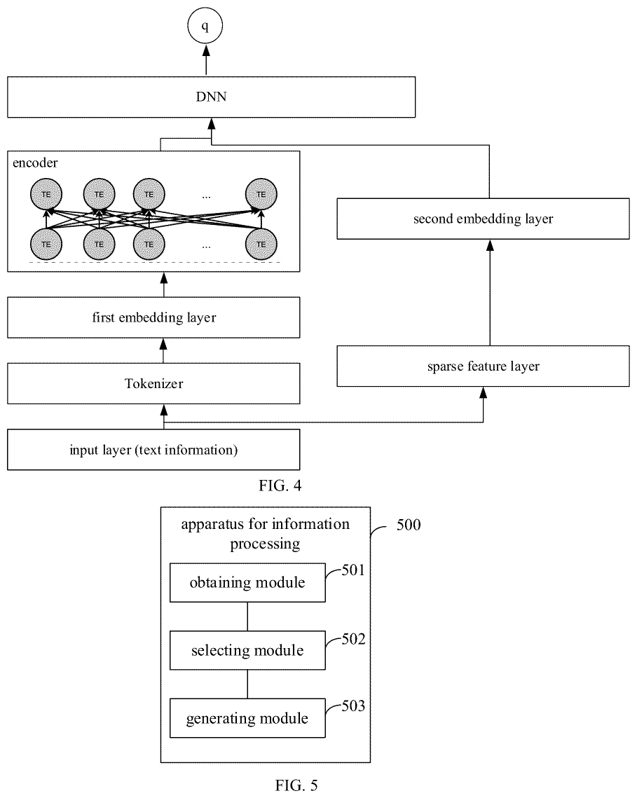

FIG. 4 is a flowchart of a method for information processing according to the embodiments of the present disclosure. As shown in FIG. 4, a model for information processing may be a pre trained Multilingual Text to Text Transfer Transformer (MT5) model and a DNN. In the disclosure, the text information may be input into the MT5 model, and the MT5 model may segment the text information to obtain a plurality of tokens. The tokens are further encoded to obtain a token ID of each token and the ID of the sparse feature of the text information. Furthermore, the candidate prompt is predicted based on the token ID of each token and the ID of the sparse feature to obtain a predicted label of the candidate prompt, which may be the comment staying duration. Optionally, the comment staying duration may be a normalized value in the range of 0˜1.

In some embodiments, the MT5 model may include an input layer, a tokenizer, a first embedding layer, an encoder, a sparse feature layer, and a second embedding layer. The input layer Tokenizer, the first embedding layer and the encoder are sequentially connected, the input layer is connected to the sparse feature layer, the sparse feature layer is connected to the second embedding layer, and both the encoder and the second embedding layer are connected to the DNN.

In some embodiments, the encoder may be a Transformer structure with a self attention mechanism.

In the embodiment, the text information from the input layer is further input into the tokenizer, which performs token segmentation on the text information to obtain a plurality of tokens. Furthermore, the token(s) output by the tokenizer is/are input into the first embedding layer, via which the token(s) is/are processed to obtain a representation vector of the token(s). Furthermore, the representation vector of the token(s) is input into the encoder for encoding to obtain the encoded vector of the text information, which carries the token ID information. Furthermore, the text information from the input layer is further input into the sparse feature layer, via which the sparse feature is extracted, and the ID of the sparse feature is input into the second embedding layer, so as to process the sparse feature and obtain the representation vector of the sparse feature.

Furthermore, the encoding vector of the text information and the representation vector of the sparse features are input into the DNN, which outputs the predicted label (i.e., comment staying duration) of the candidate prompt based on the encoding vector of the text information and the representation vector of the sparse feature. Optionally, the concatenated vector may be input into a classification head consisting of a multi-layer fully connected layer and a corresponding activation function to reduce the dimensionality of the concatenated vector. The final output is an estimated score with a value between 0-1, which is used to represent the comment staying duration. The higher the score, the longer the comment staying duration, and the lower the score, the shorter the comment staying duration.

In the method for information processing in the embodiments of the present disclosure, the optimal target prompt is selected from the candidate prompts based on the text information of the resource to be commented on and the candidate prompts, and the selected target prompt best matches the style of the resource to be commented on, so that the generated comment information of the resource to be commented on may be suitable for the content of the resource to be commented on, which not only improves the quality of the comment information and make more users view more richer comments, but also improves the accuracy and intelligence level of the comment information, and is conducive to increasing the user experiences on the resource sharing platform. Especially, a number of comments is often related to a popularity of resources on the social media platforms. The intelligent comments may simplify a commenting operation, improve a commenting speed, and quickly increase a volume of comments, and it may be easier to push the resource to be commented on. By guiding the network traffic with the intelligent comments, more users may pay attention to the resource to be evaluated. Meanwhile, the intelligent comments may also be used to handle user inquiries and feedback, which may solve the problem of untimely feedback and further enhance the user satisfaction and the user experiences.

Corresponding to the method for information processing in the above several embodiments, one embodiment of the present disclosure also provides an apparatus for information processing. As the apparatus for information processing in the embodiments of the present disclosure corresponds to the method for information processing in the above several embodiments, the implementation of the above method for information processing is also applicable to the apparatus for information processing in the embodiments of the present disclosure, which will not be described in detail in the following embodiments.

FIG. 5 is a block diagram of an apparatus for information processing according to the embodiments of the present disclosure.

As shown in FIG. 5, the apparatus 500 for information processing includes an obtaining module 501, a selecting module 502, and a generating module 503.

The obtaining module 501 is configured to obtain text information, in which the text information includes first text information of a resource to be commented on and second text information of a candidate prompt.

The selecting module 502 is configured to select an optimal target prompt from the candidate prompts based on the text information.

The generating module 503 is configured to generate comment information of the resource to be commented on, based on the resource to be commented on and the target prompt.

In some embodiments, the obtaining module 501 is further configured to: predict a quality parameter of the candidate prompt based on the text information; and select the optimal target prompt from the candidate prompts based on the quality parameters of the candidate prompts.

In some embodiments, the quality parameter is a comment staying duration, and the selecting module 502 is further configured to: rank the candidate prompts based on the comment staying durations, and select a candidate prompt with a longest comment staying duration as the target prompt.

In some embodiments, the selecting module 502 is further configured to: segment the text information into a token, and obtain an encoding vector of the text information based on the token; extract a sparse feature from the text information and obtain a representation vector of the sparse feature; and predict the quality parameters of the candidate prompts based on the encoding vector and the representation vector of the sparse feature.

In some embodiments, the selecting module 502 is further configured to: segment the text information into the token via a tokenizer, and obtain a representation vector of the token by processing the token via a first embedding layer; and obtain the encoding vector of the text information by encoding the representation vector of the token via the encoder, in which the encoding vector carries token ID information of the token.

In some embodiments, the selecting module 502 is further configured to: obtain an ID of the sparse feature, and obtain the representation vector of the sparse feature by processing the ID of the sparse feature via a second embedding layer.

In some embodiments, the selecting module 502 is further configured to: obtain a concatenated vector by concatenating the encoding vector and the representation vector of the sparse feature; and input the concatenated vector into a DNN based on a MLP, and predict the quality parameters of the candidate prompts by the DNN based on the concatenated vector.

In some embodiments, the obtaining module 501 is further configured to: obtain at least one piece of key information of the resource to be commented on, and generate the first text information based on the at least one piece of the key information, in which the key information includes at least a title, a topic and summary information.

In some embodiments, the obtaining module 501 is further configured to: in response to determining that the resource to be commented on does not carry the at least one piece of the key information, perform a semantic analysis and a content understanding of the resource to be commented on, and generate the first text information based on understanding information.

In some embodiments, the obtaining module 501 is further configured to: obtain original content of the candidate prompt and extract the second text information from the original content of the candidate prompt.

In some embodiments, the obtaining module 501 is further configured to: determine a number of words to be extracted, and obtain the second text information by extracting from front to back based on the number of the words to be extracted from the original content of the candidate prompt.

In some embodiments, the obtaining module 501 is further configured to: obtain the text information by combining the first text information and the second text information based on a preset template.

In some embodiments, the comment information of the resource to be commented on includes at least one of: a comment text of the resource to be commented on, a comment picture of the resource to be commented on, a comment audio of the resource to be commented on, or a comment video of the resource to be commented on.

In the apparatus for information processing in the embodiments of the present disclosure, the optimal target prompt is selected from the candidate prompts based on the text information of the resource to be commented on and the candidate prompts, and the selected target prompt best matches the style of the resource to be commented on, so that the generated comment information of the resource to be commented on may be suitable for the content of the resource to be commented on, which not only improves the quality of the comment information and make more users view more richer comments, but also improves the accuracy and intelligence level of the comment information, and is conducive to increasing the user experiences on the resource sharing platform. Especially, a number of comments is often related to a popularity of resources on the social media platforms. The intelligent comments may simplify a commenting operation, improve a commenting speed, and quickly increase a volume of comments, and it may be easier to push the resource to be commented on. By guiding the network traffic with the intelligent comments, more users may pay attention to the resource to be evaluated. Meanwhile, the intelligent comments may also be used to handle user inquiries and feedback, which may solve the problem of untimely feedback and further enhance the user satisfaction and the user experiences.

In the technical solution of the disclosure, the acquisition, storage, and application of personal information of the users are all in compliance with relevant laws and regulations, and do not violate public order and morals.

According to embodiments of the disclosure, an electronic device, a readable storage medium, and a computer program product are also provided.

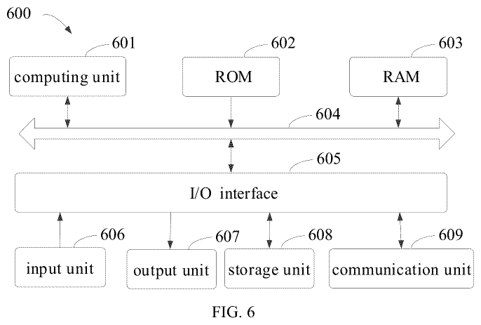

Referring to FIG. 6, it is a block diagram illustrating an electronic device 600 according to the embodiments of the disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relations, and their functions are merely examples, which are not intended to limit the implementations of the disclosure described and/or required herein.

As shown in FIG. 6, the device 600 includes a computing unit 601, configured to execute various appropriate actions and processes according to computer programs/instructions stored in a read-only memory (ROM) 602 or computer programs/instructions loaded from a storage unit 608 to a random access memory (RAM) 603. In the RAM 603, various programs and data required for the device 600 may be stored. The computing unit 601, the ROM 602 and the RAM 603 may be connected with each other by a bus 604. An input/output (I/O) interface 605 is also connected to the bus 604.

The plurality of components in the device 600 are connected to the I/O interface 605, which include: an input unit 606, for example, a keyboard, a mouse; an output unit 607, for example, various types of displays, speakers; a storage unit 608, for example, a magnetic disk, an optical disk; and a communication unit 609, for example, a network card, a modem, a wireless transceiver. The communication unit 609 allows the device 600 to exchange information/data through a computer network such as Internet and/or various types of telecommunication networks with other devices.

The computing unit 601 may be various types of general and/or dedicated processing components with processing and computing abilities. Some examples of a computing unit 601 include but not limited to a central processing unit (CPU), a graphics processing unit (GPU), various dedicated artificial intelligence (AI) computing chips, various computing units on which a machine learning model algorithm is running, a digital signal processor (DSP), and any appropriate processor, controller, microcontroller, etc. The computing unit 601 executes various methods and processes as described above, for example, the method for information processing. For example, in some embodiments, the method for information processing may be further implemented as a computer software program, which is tangibly contained in a machine readable medium, such as the storage unit 608. In some embodiments, a part or all of the computer programs/instructions may be loaded and/or installed on the device 600 via the ROM 602 and/or the communication unit 609. When the computer programs/instructions are loaded on the RAM 603 and executed by the computing unit 601, one or more steps in the method for information processing may be performed as described above. Optionally, in other embodiments, the computing unit 601 may be configured to perform the method for information processing in other appropriate ways (for example, by virtue of a firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs/instructions, the one or more computer programs/instructions may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided for the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMs, ROMs, Electrically Programmable Read-Only-Memory (EPROM), fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user may provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein may be implemented in a computing system that includes background components (for example, a data server), or a computing system that includes middleware components (for example, an application server), or a computing system that includes front-end components (for example, a user computer with a graphical user interface or a web browser, through which the user may interact with the implementation of the systems and technologies described herein), or include such background components, intermediate computing components, or any combination of front-end components. The components of the system may be interconnected by any form or medium of digital data communication (e.g., a communication network). Examples of communication networks include: a local area network (LAN), a wide area network (WAN), the Internet and a blockchain network.

The computer system may include a client and a server. The client and server are generally remote from each other and interacting through a communication network. The client-server relation is generated by computer programs/instructions running on the respective computers and having a client-server relation with each other. The server may be a cloud server, a server of a distributed system, or a server combined with a block-chain.

It should be understood that the various forms of processes shown above may be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions may be made according to design requirements and other factors. Any modification, equivalent replacement and improvement made within the principle of the disclosure shall be included in the protection scope of the disclosure.

1. A computer-implemented method for information processing, comprising:
obtaining text information, wherein the text information comprises first text information of a resource to be commented on and second text information of a candidate prompt;
selecting a target prompt from the candidate prompts based on the text information; and
generating comment information of the resource to be commented on, based on the resource to be commented on and the target prompt.

2. The method of claim 1, wherein selecting the target prompt from the candidate prompts based on the text information comprises:
predicting a quality parameter of the candidate prompt based on the text information; and
selecting the target prompt from the candidate prompts based on the quality parameters of the candidate prompts.

3. The method of claim 2, wherein the quality parameter is a comment staying duration, wherein selecting the target prompt from the candidate prompts based on the quality parameters of the candidate prompts comprises:
ranking the candidate prompts based on the comment staying durations of the candidate prompts, and selecting a candidate prompt with a longest comment staying duration as the target prompt.

4. The method of claim 2, wherein predicting the quality parameters of the candidate prompts based on the text information comprises:
segmenting the text information into one or more tokens, and obtaining an encoding vector of the text information based on the one or more tokens;
extracting a sparse feature from the text information and obtaining a representation vector of the sparse feature; and
predicting the quality parameters of the candidate prompts based on the encoding vector of the text information and the representation vector of the sparse feature.

5. The method of claim 4, wherein segmenting the text information into the one or more tokens and obtaining the encoding vector of the text information based on the one or more tokens comprises:
segmenting the text information into the one or more tokens via a tokenizer, and obtaining the representation vector of each token by processing each token via a first embedding layer; and
obtaining the encoding vector of the text information by encoding the representation vector of each token via an encoder, wherein the encoding vector carries identity (ID) information of each token.

6. The method of claim 4, wherein obtaining the representation vector of the sparse feature comprises:
obtaining an identity (ID) of the sparse feature, and obtaining the representation vector of the sparse feature by processing the ID of the sparse feature via a second embedding layer.

7. The method of claim 4, wherein predicting the quality parameters of the candidate prompts based on the encoding vector of the text information and the representation vector of the sparse feature comprises:
obtaining a concatenated vector by concatenating the encoding vector of the text information and the representation vector of the sparse feature; and
inputting the concatenated vector into a deep neural network (DNN) based on a multilayer perceptron (MLP), and predicting the quality parameters of the candidate prompts by the DNN based on the concatenated vector.

8. The method of claim 1, wherein obtaining the first text information comprises:
obtaining at least one piece of key information of the resource to be commented on, and generating the first text information based on the at least one piece of the key information, wherein the key information comprises at least one of a title, a topic or summary information.

9. The method of claim 8, wherein obtaining the first text information comprises:
in response to determining that the resource to be commented on does not carry the at least one piece of the key information, obtaining understanding information by performing semantic analysis and content understanding of the resource to be commented on, and generating the first text information based on the understanding information.

10. The method of claim 1, wherein obtaining the second text information comprises:
obtaining original content of the candidate prompt and extracting the second text information from the original content of the candidate prompt.

11. The method of claim 10, wherein extracting the second text information from the original content of the candidate prompt comprises:
determining a number of words to be extracted, and obtaining the second text information by extracting from front to back based on the number of the words to be extracted from the original content of the candidate prompt.

12. The method of claim 1, further comprising:
obtaining the text information by combining the first text information and the second text information based on a preset template.

13. The method of claim 1, wherein the comment information of the resource to be commented on comprises at least one of: a comment text of the resource to be commented on, a comment picture of the resource to be commented on, a comment audio of the resource to be commented on, or a comment video of the resource to be commented on.

14. An electronic device, comprising:
at least one processor; and
a memory connected in communication with the at least one processor and storing instructions executable by the at least one processor, wherein the at least one processor is configured to:
obtain text information, wherein the text information comprises first text information of a resource to be commented on and second text information of a candidate prompt;
select a target prompt from the candidate prompts based on the text information; and
generate comment information of the resource to be commented on, based on the resource to be commented on and the target prompt.

15. The electronic device of claim 14, wherein the at least one processor is further configured to:
predict a quality parameter of the candidate prompt based on the text information; and
select the target prompt from the candidate prompts based on the quality parameters of the candidate prompts.

16. The electronic device of claim 15, wherein the quality parameter is a comment staying duration, wherein the at least one processor is further configured to: rank the candidate prompts based on the comment staying durations of the candidate prompts, and select a candidate prompt with a longest comment staying duration as the target prompt; and/or
wherein the at least one processor is further configured to: segment the text information into one or more tokens, and obtain an encoding vector of the text information based on the one or more tokens; extract a sparse feature from the text information and obtaining a representation vector of the sparse feature; and predict the quality parameters of the candidate prompts based on the encoding vector of the text information and the representation vector of the sparse feature.

17. The electronic device of claim 16, wherein the at least one processor is further configured to:
segment the text information into the one or more tokens via a tokenizer, and obtain the representation vector of each token by processing each token via a first embedding layer;
obtain the encoding vector of the text information by encoding the representation vector of each token via an encoder, wherein the encoding vector carries identity (ID) information of each token;
obtain an identity (ID) of the sparse feature, and obtain the representation vector of the sparse feature by processing the ID of the sparse feature via a second embedding layer;
obtain a concatenated vector by concatenating the encoding vector of the text information and the representation vector of the sparse feature; and
input the concatenated vector into a deep neural network (DNN) based on a multilayer perceptron (MLP), and predict the quality parameters of the candidate prompts by the DNN based on the concatenated vector.

18. The electronic device of claim 14, wherein the at least one processor is further configured to:
obtain at least one piece of key information of the resource to be commented on, and generate the first text information based on the at least one piece of the key information, wherein the key information comprises at least one of a title, a topic or summary information;
obtain original content of the candidate prompt and extract the second text information from the original content of the candidate prompt;
obtain the text information by combining the first text information and the second text information based on a preset template; and
in response to determining that the resource to be commented on does not carry the at least one piece of the key information, obtain understanding information by performing semantic analysis and content understanding of the resource to be commented on, and generate the first text information based on the understanding information.

19. The electronic device of claim 18, wherein the at least one processor is further configured to:
determine a number of words to be extracted, and obtain the second text information by extracting from front to back based on the number of the words to be extracted from the original content of the candidate prompt.

20. A non-transitory computer-readable storage medium storing computer instructions, wherein the computer instructions are configured to cause a computer to implement a method for information processing, the method comprising:
obtaining text information, wherein the text information comprises first text information of a resource to be commented on and second text information of a candidate prompt;
selecting a target prompt from the candidate prompts based on the text information; and
generating comment information of the resource to be commented on, based on the resource to be commented on and the target prompt.
